(19) United States
(12) Patent Application Publication
(10) Pub. No.: US 2003/0154427 A1
(43) Pub. Date: Aug. 14, 2003

(54) Method for enforcing that the fail-silent property in a distributed computer system and distributor unit of such a system

(75) Inventors: Kopetz Hermann, Baden-Siegenfeld (AT); Kopetz Georg, Baden-Siegenfeld (AT)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: FTS Computertechnik G.m.b.H.

(21) Appl. No.: 10/071,991

(22) Filed: Feb. 8, 2002

(51) Int. Cl. G06F 11/30

(52) U.S. Cl. 714/31; 714/4

(57) ABSTRACT

Method for ensuring the fail-silent property in the time domain of remote communication computers (111, . . . 114) of a fault-tolerant distributed computer system, in which a plurality of remote computers are connected via a distributor unit (101, 102), each remote computer has an independent communications controller unit with the corresponding connections to the communication channels (121), and the access to the communication channels occurs by a cyclical time-division multiple access method. The at least one distributor unit makes sure, by virtue of the correct sending behavior of the remote computer that is known a priori by it, that a remote computer can only send to the other remote computers within its statically assigned time slice.

This invention concerns a method of enforcing the fail-silent property in the time domain of remote communication computers of a fault-tolerant distributed computer system, in which a plurality of remote communication computers are connected via at least one distributor unit, each remote computer has an independent communications controller with corresponding connections to the communication channels, and access to the communication channels occurs according to a cyclical time-division multiple access method.

Likewise, the invention concerns a distributor unit of a fault-tolerant distributed computer system, by which a plurality of remote computers are connected to each other, each remote computer has an independent communications controller with corresponding connections to the communication channels, and the access to the communication channels occurs by a cyclical time-division multiple access method.

Safety-critical technical applications, i.e., especially those applications in which a fault may result in a disaster, are increasingly being managed by distributed fault-tolerant real-time computer systems.

In a distributed fault-tolerant real-time computer system, consisting of a number of remote communication computers and a real-time communications system, the failure of a remote computer must be tolerated. At the heart of such a computer architecture is a fault-tolerant real-time communications system for the predictably fast and secure exchange of messages.

One communication protocol which fulfills these requirements is described in EP 0 658 257 A (WO 94/06080). This protocol has become familiar by the title of “Time-Triggered Protocol/C (TTP/C)”. It is based on the familiar cyclical method of time-division multiple access (TDMA) with a priori established time slices. The TTP/C protocol uses a method for fault-tolerant clock synchronization that is disclosed in U.S. Pat. No. 4,866,606 A.

The TTP/C protocol presupposes that the communications system supports a logical broadcast topology and that the remote communication computers from the standpoint of the recipient exhibit a “fail-silence” (Kopetz, p.121) fault behavior, i.e., either the remote computers are functioning correctly in the range of values and in the time domain or they are silent. This is described in Kopetz, H. (1997), “Real-Time Systems, Design Principles for Distributed Embedded Applications”; ISBN: 0-7923-9894-7, Boston, Kluwer Academic Publishers. The prevention of faults in the time domain, i.e., the so-called “babbling idiot” fault (Kopetz, p. 130, and also Annual Int. Symposium on Fault-Tolerant Computing, Jun. 23, 1998, pages 218-277, IEEE Computer Soc., Los Alamitos, Calif., US; Temple C.: “Avoiding the Babbling-Idiot Failure in a Time-Triggered Communications system”), is achieved in the TTP/C protocol by an independent fault recognition unit, the so-called “guardian”, which has an independent time base and continuously checks up on the time behavior of the remote computer. In order to achieve fault tolerance, several fail-silent remote computers are assembled into a fault-tolerant unit (FTU) and replicate the communications system. As long as one remote computer of a FTU and one replica of the communications system are functioning, the services of the FTU are properly provided in the time domain and the range of values.

A logical broadcast topology of communication can be physically constructed either by a distributed bus system, a distributed ring system, or by a distributor unit, e.g., a star coupler, with point-to-point connections to the remote computers, or by a combination of these topologies. If a distributed bus system or a distributed ring system is constructed, each remote computer must have its own guardian.

One object of the invention is to increase the fault tolerance of a distributed time-controlled computer system and to lower the costs.

This object is achieved by a method of the kind mentioned in the beginning, in which according to the invention the at least one distributor unit makes sure, by virtue of the correct transmission behavior of the remote computer that is known a priori to it, that a remote computer can only transmit to the other remote computers within a statically assigned time slice.

By integrating a “guardian” into the intelligent distributor unit, it is possible to prevent “babbling idiot” faults of the remote computer, i.e., the sending of messages at the wrong time.

If a distributor unit is employed according to the invention, all guardians can be integrated in this distributor unit, which can effectively enforce a correct transmitting behavior in the time domain by virtue of global observation of the behavior of all remote computers.

Such distributor units with integrated guardian offer the following advantages:

(i) The fault containment region for global critical faults is reduced by the point-to-point connections of the remote computers to the distributor unit, i.e., faults which are introduced by EMI (electromagnetic immission) into these point-to-point connections can be clearly assigned to one remote computer and do not have any global effect.

(ii) The replicated global-critical distributor units can be installed with spatial separation in protected areas and have a physically compact structure. This significantly reduces the probability that a fault-causing factor will disrupt all global-critical distributor units.

(iii) The guardian of the distributor unit replaces the decentralized guardians in the remote computers. This saves on hardware for the remote computers, such as the guardian oscillators.

(iv) Physical point-to-point connections are well suited to the introduction of optical fibers and also bring advantages in impedance matching for twisted cables.

Likewise, the object is accomplished with a distributor unit of the above-mentioned kind, in which according to the invention the distributor unit is designed to ensure, by virtue of the correct transmission behavior of the remote computer that is a priori known to it, that a remote computer can only send successfully to the other remote computers within a statically assigned time slice.

The function of the distributor unit is based on the evaluation of a combination of static a priori information about the send time authorization of the individual remote computers with a dynamic synchronization of the distributor unit by the messages of a time-controlled communications system.

The invention along with its other advantages is explained more closely hereafter by means of embodiment examples, which are illustrated in the drawing. This shows:

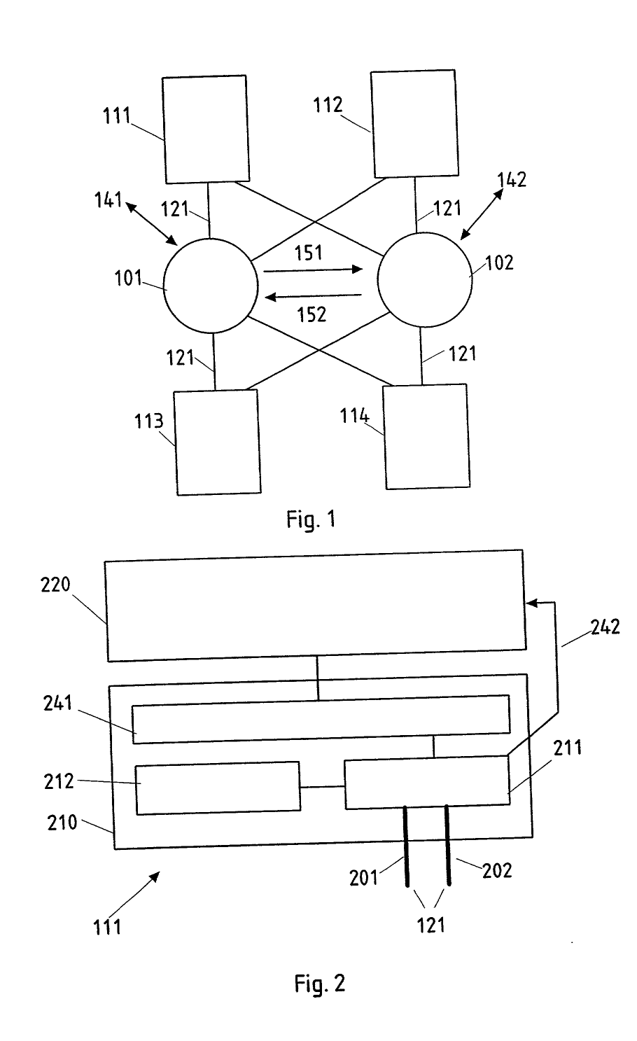

FIG. 1, the structure of a distributed computer system with four remote computers, which are joined via two replicated distributor units,

FIG. 2, the structure of a remote computer, consisting of a communications controller and a host computer, which communicate by a communication network interface (CNI),

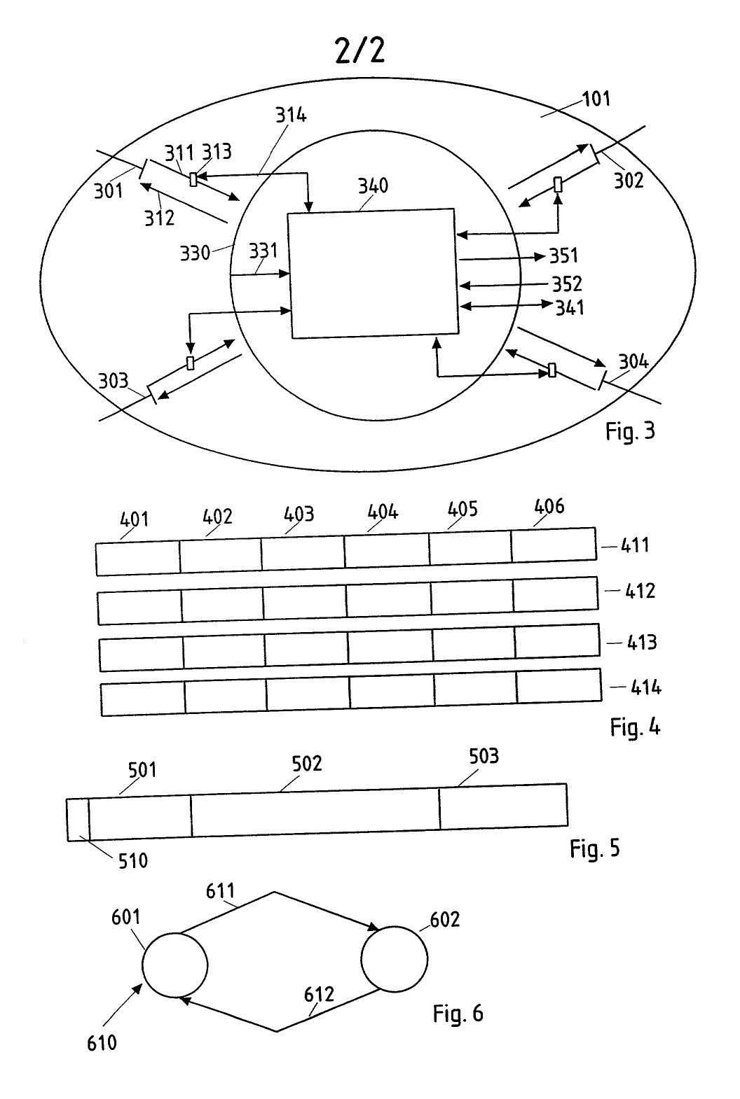

FIG. 3, the structure of a distributor unit with integrated guardian,

FIG. 4, the data structure of the information which the distributor unit contains a priori,

FIG. 5, the structure of an initialization message, and

FIG. 6, the internal states of the distributor unit.

In the next section, we shall present an embodiment of the invention by an example with four remote computers, which are connected via two replicated distributor units. The objects in the drawings are numbered such that the first of the three-place reference numbers always pertains to the number of the drawing.

FIG. 1 shows a system of four remote communication computers 111, 112, 113 and 114, wherein each remote computer forms an interchangeable unit and is connected via a point-to-point connection 121 to each of two replicated distributor units 101 and 102. From the first distributor unit 101, a unidirectional communications channel 151 leads to the other second distributor unit 102. Vice versa, from the distributor unit 102 a unidirectional communications channel 152 goes to the distributor unit 101. Through these unidirectional communications channels, the first distributor unit 101 can observe the traffic at the second distributor unit 102 and vice versa, and it can also carry out a cold start or clock synchronization if there is no message traffic at its own connections 121. The indicated connections 141 and 142 are dedicated communications channels; they lead to a maintenance computer (not shown in the drawing), which can establish the parameters of the distributor units and continuously monitors the proper functioning of the distributor units.

FIG. 2 shows the internal makeup of a remote communications computer 111. It consists of two subsystems, namely, a communications controller 210, which is connected to the replicated communications channels 201 and 202 (corresponding to 121 in FIG. 1), and a host computer 220, on which the application programs of the remote computer are executed. These two subsystems are joined to each other via a communication network interface (CNI) 241 and a signal line 242. The interface 241 contains a memory (dual ported RAM=DPRAM), which both subsystems can access. The two subsystems exchange the communications data via this common memory and interface 241. The signal line 242 serves to carry the synchronized time signals. This signal line is described precisely in the mentioned U.S. Pat. No. 4,866,606 A. The communications controller 210, which works autonomously, has a communications control unit 211 and a data structure 212 that indicates the moments of time when messages need to be sent and received. The data structure 212 is designated a message descriptor list (MEDL).

FIG. 3 shows the structure of a distributor unit with integrated guardian. Such a distributor unit consists of input ports 311, output ports 312, a data distributor 330 and a control computer 340. The data connections 309 of the remote computer (corresponding to 121 in FIG. 1) are taken to an input port 311 and an output port 312 of the distributor unit. The same goes for data connections 302, 303 and 304. In the case of an unidirectional communication line, these two ports 311 and 312 can also be connected separately to corresponding ports of the remote computer with the data connection 301. In each input port 311, besides the customary filters and a potential separation (if necessary), there is a switch 313, which can be activated by the control computer 340 of the distributor unit via a signal line 314 and which tells the control computer 340 when to receive at this port. The data arriving at the input port 311 are relayed via the data distributor 330 to the output ports 312, the control computer 340 (via the data line 331), and other distributor units (via channel 351). The control computer 340 also has a serial I/O channel 341, by which the static data structure can be loaded per FIG. 4, and which periodically sends a diagnostic report as to the status of the control computer 340 to a maintenance computer. If necessary, the data on the lines 312 can be amplified prior to the output. Such amplifiers, which are part of the state of the art, are not shown in FIG. 3.

FIG. 4 shows the data structure which is made available to the control computer 340 a priori, i.e., before its transit time. This data structure contains a special data record 411, 412, 413, 414 for each port or remote computer 111, 112, 113, 114 of the distributor unit. In a first field of this data record 401 comes the port number to which this data record pertains. In a second field 402 comes the send time duration of the node associated with the port as entered in the list MEDL 212. In a third field 403 comes the duration of the time interval between the end of the current send and the start of the next send of the node associated with the port. In a fourth field 404 comes the number of the next port in time. In a fifth field 405 comes the duration of the time interval between the end of the current send and the start of the sending of the node at the next port in time. In the field 406 comes the length of an initialization message, which can be received at the current port. The content of the data structure of FIG. 4 is established by a development tool in coordination with the message descriptor lists 212 and loaded into the control computer 340 prior to the transit time via channel 341.

FIG. 5 shows the structure of an initialization message. The initialization message must contain a special bit 510 in the header 501, which characterizes the message as an initialization message. In data field 502 of the initialization message comes additional information not important to the functioning of a simple distributor unit. At the end of the initialization message is the CRC field 503. Sophisticated distributor units can evaluate the information in data field 502 of an initialization message to further enhance the probability of fault recognition. For example, such sophisticated distributor units can evaluate the time field of a TTP/C initialization message in order to compare the clock status of the sender against their own clock.

FIG. 6 shows the two most important internal states of the control computer 340 of a distributor unit 101, unsynchronized 601 and synchronized 602. After power-up 610, the control computer 340 goes into the “unsynchronized” state. In this state, all input ports 311 are connected to the data distributor 330. As soon as a correct message is received at an input port via the data line 331 (or via the channel 352) from the control computer 340, the control computer 340 establishes by the signal line 314 the port that was used to receive, saves the reception time point in memory, checks the length of the message by comparing with the length saved in field 406, and if the outcome of the check is positive it goes into the “synchronized” state 602, wherein the memorized reception time point of the initialization message represents the synchronization event. In the “synchronized” state 602, the control computer 340 establishes a connection at the corresponding input port only for the time duration 403. If a particular message arrives at approximately the correct moment of time, which corresponds to the encoding rules of the selected encoding system, the control computer will use the measured difference in time between the observed and the anticipated arrival time for the message to resynchronize its clock using a familiar fault-tolerant algorithm (e.g., Kopetz 1997, p. 61). If no correct message arrives during an a priori established time interval d_{fault-1} on any of the channels 301-304 or 352, the distributor unit or its control computer 340 switches to the “unsynchronized” state 601. In the synchronized state 602, a message is correct if it fulfills at least the following criteria: it arrives at the input port approximately at the anticipated time, it has a correct CRC field 503, and it has the correct length according to the field 406.

The control computer 340 communicates via the I/O line 341 (lines 141 and 142 in FIG. 1) with the maintenance computer, which undertakes the parameterization of the control computer 340 and monitors the functioning of the control computer during its operation.

A single error in the clock of a remote computer, such as 111, can result in a marginally wrong encoding of the physical signals on both channels 201 and 202 of the remote computer 111. In order to prevent this from propagating to the recipient of the message via the two distributor units, the incoming physical signal in each distributor unit is converted directly after its reception into a logical signal (“digital signal”), using the local clock of the distributor unit, and again converted into physical form immediately prior to the sending by the distributor unit (signal reshaping by the distributor unit). In this way, a marginally wrong encoding is depicted either as a consistently correct encoding or a consistently wrong encoding. Assuming that only one error source occurs within a TDMA round, this step can prevent a single error in the time domain or in the range of values from disturbing the encoding on both channels so that inconsistencies might occur in the system.

It is an important property of this invention that the control computer 340 can only bring about the opening and closing of the switch 313, but can neither alter the contents of the transiting messages nor insert new messages. Therefore, the only type of fault of the distributor unit is a fail-silent fault of a communication channel. Yet in a fault-tolerant configuration there is always a second independent communication channel available.

Finally, it should be noted that the invention is not limited to the described embodiment with four remote computers and two distributor units, but rather can be expanded at will. It can be used not only with TTP/C protocol, but also other time-controlled protocols.

1. A method for enforcing the fail-silent property in the time domain of remote communication computers (111, . . . , 114) of a fault-tolerant distributed computer system, in which a plurality of remote computers are connected via a distributor unit (101, 102), each remote computer has an independent communications control unit (210) with the corresponding connections to the communication channels, and the access to the communication channels occurs by a cyclical time-division multiple access method
characterized in that
the at least one distributor unit (101, 102) makes sure, by virtue of the correct transmission behavior of the remote computer (111, . . . , 114) that is known a priori by it, that a remote computer can only send successfully to the other remote computers within its statically assigned time slice.

2. The method according to claim 1, further further characterized in that the at least one distributor unit (101, 102) switches from the “unsynchronized” state, in which receiving is possible via all input ports (311), after receiving a correct message, to the “synchronized” state, in which receiving is only possible via one input port during the time slice statically assigned to this input port.

3. The method according to claim 1 or 2, further characterized in that the at least one distributor unit (101, 102) switches from the “synchronized” state to the “unsynchronized” state when no correct message has been received since the last initialization message at any of its input ports (311) within an a priori specified time interval.

4. The method according to one or more of claims 1 to 3, further characterized in that in a distributor unit (101, 102) the content of arriving messages is evaluated as an additional fault recognition.

5. The method according to one or more of claims 1 to 5, further characterized in that the at least one distributor unit (101, 102) assumes the “unsynchronized” state after “power-up”.

6. The method according to one or more of claims 1 to 6, further characterized in that the at least one distributor unit (101, 102) converts the arriving physical signals into digital form, using the local clock of the distributor unit, and converts them back into the physical form before sending them.

7. The method according to one or more of claims 1 to 6, further characterized in that distributor units (101, 102) are connected to each other via communication channels (201, 202) in order to enable the power-up and clock synchronization of a distributor unit, even when no messages arrive at its own connections.

8. The method according to one or more of claims 1 to 6, further characterized in that distributor units are connected via dedicated communication channels (141, 142) to at least one maintenance computer, which performs the parameterization of the distributor units and monitors the correct functioning of the distributor units during operation.

9. A distributor unit (101, 102) of a fault-tolerant distributed computer system, by which a plurality of remote computers (111, . . . , 114) are connected to each other, each remote computer has an independent communications control unit (211) with corresponding connections to the communication channels (201, 202), and access to the communication channels occurs by a cyclical time-division multiple access method,
further characterized in that
the at least one distributor unit (101, 102) is designed to make sure, by virtue of the proper transmission behavior of the remote computer that is known a priori by it, that a remote computer can only send successfully to the other remote computers within its statically assigned time slice.

10. The distributor unit (101, 102) according to claim 9, designed to carry out the method according to one of claims 2 to 8.
